(19) United States
(12) Patent Application Publication
(10) Pub. No.: US 2026/0086291 A1
(43) Pub. Date: Mar. 26, 2026

(54) OPTICAL SYSTEM FOR A DISPLAY

(71) Applicant: Lumus Ltd., Ness Ziona (IL)

(72) Inventor: Yochay DANZIGER, Kfat Vradim (IL)

(21) Appl. No.: 19/130,961

(22) PCT Filed: Jun. 13, 2024
(86) PCT No.: PCT/IL2024/050588

§ 371 Date: May 19, 2025

Related U.S. Application Data
(60) Provisional application No. 63/472,649, filed on Jun. 13, 2023.

(51) Int. Cl. G02B 6/34

(52) U.S. Cl. CPC G02B 6/34

(57) ABSTRACT

An optical system (100, 111, 125, 126, 127, 128) includes an aperture-expanding lightguide optical element (LOE) (106) with major surfaces (103a, 103b) separated by a first thickness T1. The LOE (106) includes redirecting configurations for progressively redirecting light within the LOE and coupling it out towards a viewer. A coupling-in arrangement includes a coupling lightguide element (CLE) (104) with mutually parallel surfaces separated by a second thickness T2 that is no more than half of the first thickness T1. CLE (104) is bonded to major surface (103a) at an interface (105) provided with a beam splitter coating having a reflectivity of at least 50%. The coupling-in arrangement also includes an input coupler deployed to couple light corresponding to a collimated image into the CLE.

### FIELD AND BACKGROUND OF THE INVENTION

The present invention relates to optical systems for displays and, in particular, it concerns configurations for image injection into a lightguide optical element with optical aperture expansion.

Lightguide-based displays employ a lightguide, typically in the form of a slab having mutually parallel front and rear surfaces, to guide an image in front of the eye of the user for coupling out towards the eye for viewing. In some cases, the lightguide may achieve one- or two-dimensional optical aperture expansion by progressively redirecting the light within the lightguide and/or in the coupling out process. Progressive redirection of the light is typically performed either by a set of embedded partial reflectors or by diffractive optical elements.

Coupling an image into the lightguide presents design challenges. Optimal image uniformity is achieved when the image light “fills” the lightguide thickness, i.e., where all rays of the image and its reflection are present at every point within the lightguide thickness. This would require a relatively large projector and coupling configuration, which is at odds with the practical objective of minimizing the size and weight of the system as much as possible.

### SUMMARY OF THE INVENTION

The present invention is an optical system.

According to the teachings of an embodiment of the present invention there is provided, an optical system comprising: (a) an aperture-expanding lightguide optical element (LOE) having a pair of mutually parallel major surfaces, separated by a first thickness, the LOE supporting propagation of light by internal reflection at the major surfaces, the LOE having: (i) a first redirecting configuration deployed in a first region of the LOE for progressively redirecting light propagating in a first in-plane direction to propagate in a second in-plane direction towards a second region of the LOE, and (ii) a second redirecting configuration deployed in the second region of the LOE for progressively redirecting light propagating in the second in-plane direction out of the LOE for viewing by a viewer; and (b) a coupling-in arrangement comprising: (i) a coupling lightguide element (CLE) having a pair of mutually parallel surfaces separated by a second thickness that is no more than half of the first thickness, the parallel surfaces of the CLE having an area that is no more than 10 percent of an area of the major surfaces of the LOE, one of the surfaces of the CLE being bonded to one of the major surfaces of the LOE at an interface, at least part of the interface provided with a beam splitter coating having a reflectivity of at least 50%, and (ii) an input coupler deployed to couple light corresponding to a collimated image into the CLE.

According to a further feature of an embodiment of the present invention, the input coupler is a coupling prism presenting an input surface that is substantially perpendicular to a chief ray of the collimated image coupled in to the CLE.

According to a further feature of an embodiment of the present invention, the first redirecting configuration comprises a first set of mutually parallel internal partially reflecting surfaces non-parallel to the major surfaces, and wherein the second redirecting configuration comprises a second set of mutually parallel internal partially reflecting surfaces obliquely angled to the major surfaces.

According to a further feature of an embodiment of the present invention, the CLE further comprises a preliminary aperture expansion arrangement.

According to a further feature of an embodiment of the present invention, the preliminary aperture expansion arrangement comprises a set of mutually parallel internal partially reflecting surfaces within the CLE for progressively redirecting the light coupled in by the input coupler.

According to a further feature of an embodiment of the present invention, the input coupler is deployed so that a chief ray of the collimated image coupled in to the CLE propagates in the first in-plane direction after a single reflection from one of the internal partially reflecting surfaces of the CLE.

According to a further feature of an embodiment of the present invention, the input coupler is deployed so that a chief ray of the collimated image coupled in to the CLE propagates in the first in-plane direction after being twice reflected from the internal partially reflecting surfaces of the CLE.

According to a further feature of an embodiment of the present invention, the preliminary aperture expansion arrangement comprises a diffractive optical element associated with the CLE.

According to a further feature of an embodiment of the present invention, the input coupler is deployed so that a chief ray of the collimated image coupled in to the CLE propagates in the first in-plane direction after being redirected twice by diffraction at the diffractive optical element so as to cancel out chromatic dispersion generated by a first diffraction at the diffractive optical element.

According to a further feature of an embodiment of the present invention, the first redirecting configuration of the LOE is a diffractive optical element configured to match the diffractive optical element of the CLE so as to cancel out chromatic dispersion generated by the diffractive optical element of the CLE.

According to a further feature of an embodiment of the present invention, a part of the interface between the CLE and the LOE that underlies the preliminary aperture expansion arrangement is provided with a highly reflective coating.

According to a further feature of an embodiment of the present invention, the input coupler is a first diffractive optical element associated with a surface of the CLE, and wherein the second redirecting configuration is a second diffractive optical element configured to match the first diffractive optical element so as to cancel out chromatic dispersion generated by the first diffractive optical element.

According to a further feature of an embodiment of the present invention, the beam splitter coating has a reflectivity of between 55% and 95%, and in certain preferred cases, between 65% and 90%.

According to a further feature of an embodiment of the present invention, the beam splitter coating has a reflectivity which progressively decreases along the first in-plane direction.

According to a further feature of an embodiment of the present invention, the second thickness is between 20% and 40% of the first thickness.

### BRIEF DESCRIPTION OF THE DRAWINGS

The invention is herein described, by way of example only, with reference to the accompanying drawings, wherein:

FIG. 1A is a schematic isometric view of an optical system, constructed and operative according to the teachings of the present invention, employing a coupling lightguide element (CLE) for introducing a collimated image into a lightguide optical element (LOE) for conveying to the eye of an observer;

FIG. 1B is a schematic plan view of the optical system of FIG. 1A;

FIGS. 2A and 2B are views similar to FIGS. 1A and 1B, respectively, illustrating a first variant implementation of the optical system of the present invention, employing a CLE with preliminary aperture expansion achieved by an even number of reflections;

FIGS. 3A and 3B are views similar to FIGS. 1A and 1B, respectively, illustrating a second variant implementation of the optical system of the present invention, employing a CLE with preliminary aperture expansion achieved by an odd number of reflections;

FIG. 4A is a schematic isometric view similar to FIG. 3A illustrating a modified implementation in which the CLE is subdivided into two parts for sequential aperture expansion and coupling into the LOE;

FIG. 4B is a schematic side view of FIG. 4A;

FIGS. 5A and 5B are views similar to FIGS. 4A and 4B, respectively, illustrating a further variant implementation of the optical system of the present invention, employing an optically matching pair of diffractive optical elements (DOE), one in the CLE and one in the LOE; and

FIG. 6 is a schematic isometric view similar to FIG. 4A illustrating a further variant implementation of the optical system of the present invention in which coupling in of light into the CLE and coupling out of the light from the LOE are achieved by an optically matching pair of DOEs.

### DESCRIPTION OF THE PREFERRED EMBODIMENTS

The present invention is an optical system and corresponding methods of producing an optical system.

The principles and operation of optical systems and corresponding methods according to the present invention may be better understood with reference to the drawings and the accompanying description.

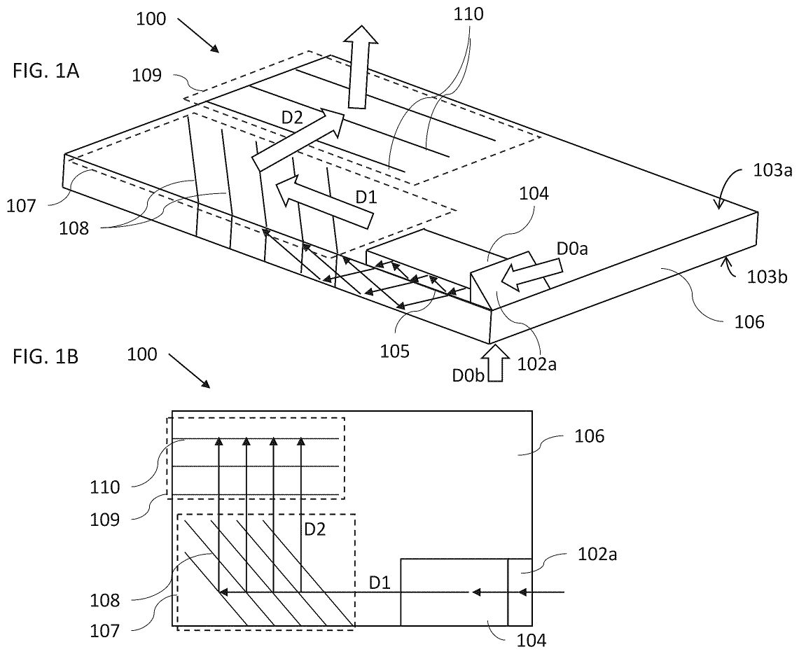

Referring now to the drawings, FIGS. 1A-6 show schematically various implementations of an optical system, constructed and operative according to the teachings of the present invention. In general terms, the optical system includes an aperture-expanding lightguide optical element (LOE) 106 having a pair of mutually parallel major surfaces 103a, 103b, separated by a first thickness T1, supporting propagation of light by internal reflection at the major surfaces. LOE 106 includes a first redirecting configuration deployed in a first region 107 of the LOE for progressively redirecting light propagating in a first in-plane direction D1 to propagate in a second in-plane direction D2 towards a second region 109 of the LOE, and a second redirecting configuration deployed in the second region 109 of the LOE for progressively redirecting light propagating in the second in-plane direction D2 out of the LOE (direction D3) for viewing by a viewer.

A coupling-in arrangement is deployed for coupling a projected image from a projector (not shown) into LOE 106. The coupling-in arrangement includes a coupling lightguide element (CLE) 104 having a pair of mutually parallel surfaces separated by a second thickness T2 that is no more than half of the first thickness T1, and in certain particularly preferred cases, between 20% and 40% of the first thickness T1. The parallel surfaces of CLE 104 have an area that is no more than 20 percent, and preferably less than 10 percent, of an area of major surfaces 103a, 103b. One of the parallel surfaces of CLE 104 is bonded to one major surface 103a of LOE 106 at an interface 105, at least part of which is provided with a beam splitter coating having a reflectivity of at least 50%. The coupling-in arrangement also includes an input coupler deployed to couple light corresponding to a collimated image into the CLE. In a first set of particularly preferred implementations illustrated in FIGS. 1A-5B, the input coupler for an input chief ray D0a is a coupling prism presenting an input surface that is substantially perpendicular to a chief ray of the collimated image coupled into the CLE. Alternatively, the prism may be a reflective prism, for example, coated with 100% reflector, for coupling in an input image with chief ray D0b impinging from the opposite side of lightguide 106. In the subsequent discussion, we refer only to the option of input direction D0a for simplicity of presentation.

The basic functionality of this aspect of the present invention may be understood with reference to FIGS. 1A and 1B, which illustrate an optical system 100, constructed and operative according to a first implementation of the present invention. The general propagation of the beams (corresponding to the chief ray of a collimated image and showing the “in-plane component” within the lightguide) is shown as block arrows in FIG. 1A, whereas specific rays are shown as black arrows. In the plan view of FIG. 1B, this distinction is not visible. The light impinges on a prism 102a that couples the light into CLE 104. Since CLE 104 is thinner than LOE 106, the coupling-in interface can be smaller, allowing use of a smaller projector (not shown) than would otherwise be required for the LOE. The partially reflecting interface 105 between CLE 104 and LOE 106 is a partial reflector results in progressive “leaking” of light from CLE 104 into LOE 106 as the light is guided within CLE 104, thereby resulting in relatively uniform illumination across the thickness of LOE 106, effectively expanding the aperture along the thickness of the lightguide and helping to “fill”the thickness of the LOE with the projected image.

In the preferred implementation illustrated here, the first redirecting configuration is implemented as a first set of mutually parallel internal partially reflecting surfaces 108 non-parallel to the major surface 103a, and the second redirecting configuration is implemented as a second set of mutually parallel internal partially reflecting surfaces 110 obliquely angled to the major surface 103a. Partially reflecting surfaces 108 progressively reflect and redirect guided light propagating in the first in-plane direction D1 within first region 107 so as to propagate towards second region 109, thereby achieving a first dimension of aperture expansion along direction D1. Partially reflecting surfaces 110 progressively couple the image light out of the lightguide within second region 109 for viewing by the user, thereby achieving a second dimension of aperture expansion along direction D2.

In addition to reducing the thickness of the entrance pupil, the coupling in configuration described herein is also advantageous due to ease of manufacture. The coupling in configuration is a small assembly which is bonded to the major surface of the lightguide, a readily accessible attachment surface, and does not require high precision of alignment.

CLE 104 is preferably deployed over a region of LOE 106 which is outside the viewing area of the user, or at least located peripherally, so that the edges of CLE 104 do not disrupt the user's view. The relatively small size of CLE 104 compared to LOE 106, covering less than 20% and preferably less than 10% of the LOE area, facilitates unobtrusive deployment of the CLE. If located peripherally within the viewing area, the beam splitter coating at interface 105 may be implemented using multi-layer dielectric coatings which have angularly dependent reflectivity, being transparent (over 90% transmission) at small incident angles, and having the desired reflectivity as defined below for larger angles that are relevant for propagation of the image within the LOE. If CLE 104 is outside the viewing area, a simple dielectric or metallic partially reflective coating may be used. CLE 104 is preferably a “slab” type lightguide, meaning that both its in-plane dimensions are at least an order of magnitude greater than its thickness.

The reflectivity of the beam splitter coating at interface 105 is preferably chosen as a function of the range of angles of the injected image and the thickness and length of CLE 104 so that a significant proportion of the image light intensity undergoes multiple internal reflections within CLE 104 while gradually “leaking” into LOE 106, and so that most of the image light intensity has escaped from CLE 104 by the end of the CLE. The preferred reflectivity is typically at least 50%, more preferably between 55% and 95%, and most preferably between 65% and 90%. In some cases, the beam splitter coating has a reflectivity which progressively decreases along the first in-plane direction, for example, as two or more strips of reflective coatings with different reflectivities.

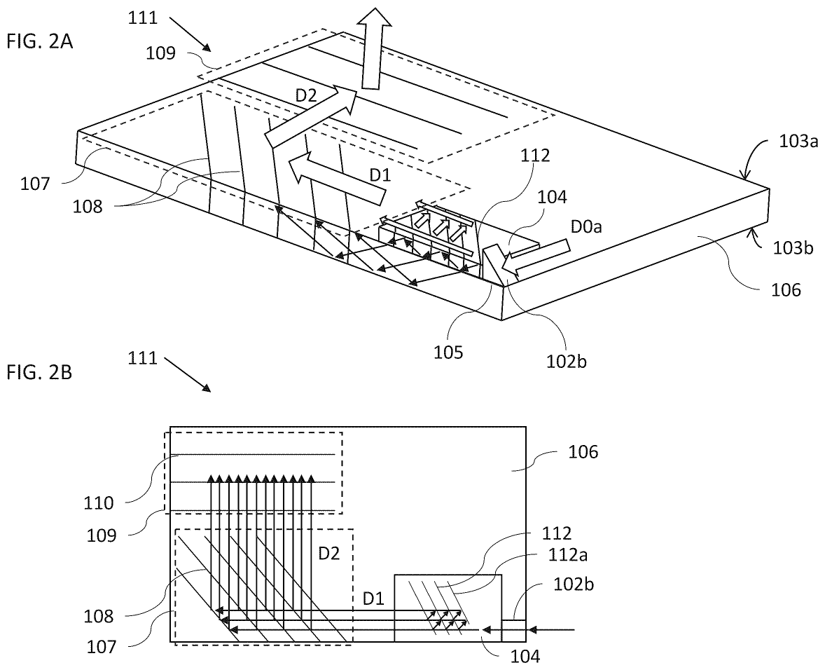

Turning now to FIGS. 2A and 2B, this illustrates a further optical system, generally designated 111, constructed and operative according to a further implementation of the present invention. Optical system 111 is generally similar in structure and function to optical system 100, with equivalent elements labeled similarly. Optical system 111 differs from optical system 100 in that CLE 104 includes a preliminary aperture expansion arrangement, here implemented as a set of mutually parallel internal partially reflecting surfaces 112 within CLE 104, for progressively redirecting the light coupled in by the input coupler. This allows the use of an entrance pupil defined by a prism 102b that is smaller than that of prism 102a in the previous implementation.

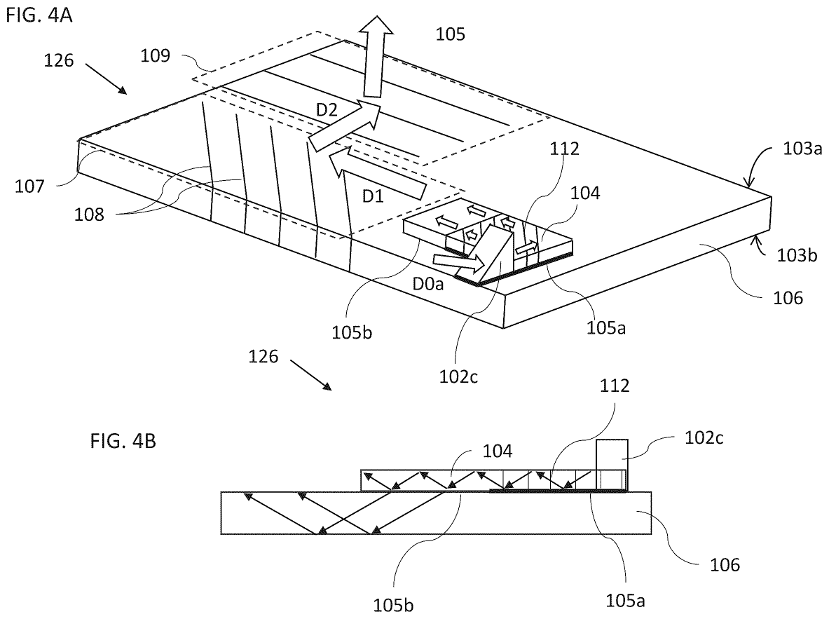

In the implementation illustrated here, the image is injected with an in-plane component parallel to direction D1, and redirected rays entering LOE 106 propagate in the first in-plane direction D1 after being reflected twice (or some other even number of times) from surfaces 112 of CLE 104. Optionally, at least part of interface 105 under the region of the partially reflecting surfaces 112 may have high reflectivity, similar to that discussed below with reference to FIGS. 4A and 4B, to minimize loss of light after an odd number of reflections in the region of the partially reflecting surfaces 112 and to limit coupling-out into lightguide 106 to a region of CLE 104 beyond surfaces 112. Additionally, or alternatively, efficiency may be enhanced by providing a first surface 112a with high reflectivity positioned so that the in-coupled light does not pass through the high reflectivity surface, but so that all light reflected an odd number of times will reach the first surface and be returned towards direction D1.

The effect of the preliminary aperture expansion arrangement is to achieve an initial broadening of the width of the image entrance pupil, thereby facilitating the use of a narrower entrance pupil into prism 102b and a correspondingly smaller image projector. Additionally, or alternatively, this preliminary in-plane expansion may relax the design requirements for the first aperture expansion arrangement, for example, allowing use of a larger spacing between successive partially reflecting surfaces 108. In all other respects, the structure and function of optical system 111 is similar to that of optical system 100 and will be understood by reference to the above description.

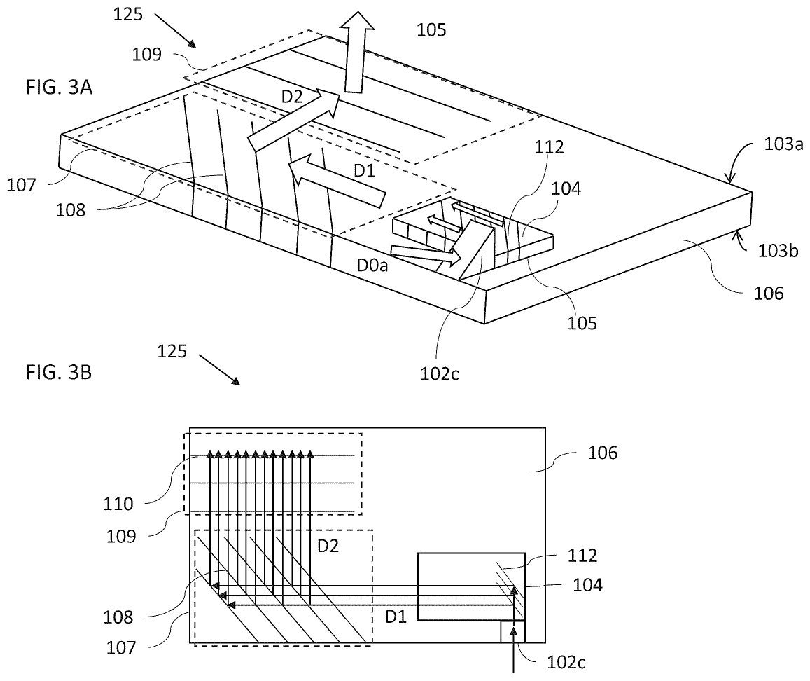

Turning now to FIGS. 3A and 3B, there is shown a further optical system, generally designated 125, constructed and operative according to a further implementation of the present invention. Optical system 125 is generally similar in structure and function to optical systems 100 and 111, with equivalent elements labeled similarly. Like optical system 111, CLE 104 of optical system 125 includes a preliminary aperture expansion arrangement implemented as a set of mutually parallel internal partially reflecting surfaces 112 for progressively redirecting the light coupled in by the input coupler. However, in this case, the image is injected via a prism 102c with an in-plane component non-parallel to direction D1, and redirected rays entering LOE 106 propagate in the first in-plane direction D1 after being reflected once (or another odd number of times) from surfaces 112 of CLE 104. Efficiency can be enhanced in this scenario by providing successively increasing reflectivities of surfaces 112 along the light path.

The direction of injection of the image light in this implementation is illustrated here as being perpendicular to first in-plane direction D1, with partially reflecting surfaces 112 at 45 degrees to D1. However, other angles of injection and corresponding orientations of surfaces 112 may be chosen.

Surfaces 112 may be vertical (orthogonal) to the major surfaces of the LOE or may be obliquely inclined. Optionally, an obliquely angled set of surfaces 112 may be used so that the injected image spans a first range of angles and the reflected image (after one reflection or another odd number of reflections) spans a second range of angles. In this case, the partially reflective coating of interface 105 may be designed to be angularly selective so as to be partially reflective in the second range of angles to allow coupling out of the reflected image while having higher reflectivity for the first range of angles, to minimize loss of light that does not contribute to the output image.

Turning now to FIGS. 4A and 4B, these illustrate an implementation of an optical system 126 similar to optical system 125 with a modified interface to enhance efficiency. Specifically, in this case, a part 105a of the interface between CLE 104 and LOE 106 underlying the preliminary aperture expansion arrangement is provided with a highly reflective coating, i.e., with reflectivity above 90% and preferably at least 95%, while the aforementioned beam splitter coating is applied in a second part 105b of the interface, beyond the preliminary aperture expansion arrangement (e.g., surfaces 112). This helps to ensure that light which is propagating in an undesired direction (e.g., after zero or an even number of reflections in the case of FIG. 4A) is not coupled out into lightguide 106, and is instead restricted to CLE 104 until it encounters additional partial reflecting surfaces 112, thus increasing the amount of light which ends up correctly directed. Light which has undergone an odd number of reflections propagates in the desired direction D1 and passes into the second part of CLE 104, where it is progressively coupled out through the second part of interface 105b, as described previously. The highly reflective coating preferably extends also beneath coupling prism 102c. This approach is equally applicable to an implementation using the geometry of FIGS. 2A and 2B, where the internal partially reflecting surfaces 112 may also be localized to a first part of CLE 104 with a highly reflective interface, and coupling out occurs in a distinct second part of CLE 104.

In all other respects, the structure and operation of optical system 126 is equivalent to that of optical system 125 and will be understood by reference to the corresponding description above.

The invention has been described thus far with reference to optical systems in which redirection of light within LOE 106 and any preliminary aperture expansion within CLE 104 are all achieved by reflective elements. It should be noted, however, that one or more of the redirecting components may alternatively be implemented using a diffractive optical element, such as a surface grating, volume grating or a holographic element, such as are, per se, known in the art. Typically, in order to avoid pronounced dispersive effects that are characteristic of diffractive optical elements, the system design should preferably employ two equal but opposite redirections performed by diffractive elements, so that the second redirection compensates for dispersive effects introduced by the first redirection.

One such embodiment, which may be understood by reference to FIG. 2A, would replace the set of partially reflective surfaces 112 in CLE 104 with a diffractive optical element associated with the CLE. Such an embodiment should be configured so that a chief ray of the collimated image coupled in to the CLE propagates in the first in-plane direction after being redirected twice by diffraction at the diffractive optical element so as to cancel out chromatic dispersion generated by a first diffraction at the diffractive optical element. All other aspects of this design would be as described above with reference to FIGS. 2A and 2B.

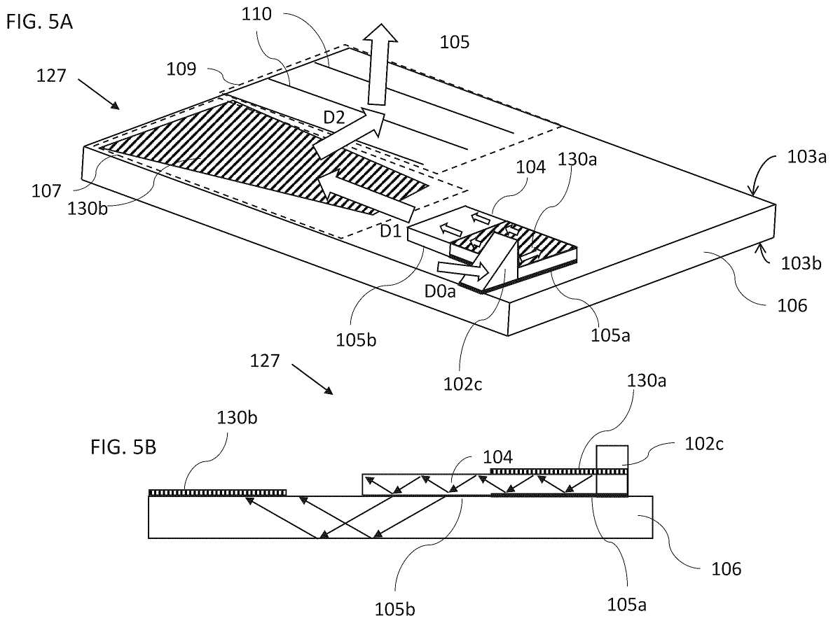

An alternative approach illustrated in FIGS. 5A and 5B provide an optical system 127 geometrically similar to optical system 126 of FIGS. 4A and 4B, but employing a diffractive optical element 130a associated with CLE 104 for preliminary aperture expansion within CLE 104 and a second diffractive optical element 130b as the first redirecting configuration of LOE 106. DOE 130b is configured to match DOE 130a so as to cancel out chromatic dispersion generated by diffractive optical element 130a of CLE 104. For this embodiment, the direction of light injection into CLE 104 should be parallel to second in-plane direction D2 so that, after two redirections, the light again leaves DOE 130b along in-plane direction D2. Coupling of image light into CLE 104 is via prism 102c and coupling out of the image towards the user's eye is achieved by partially reflecting surfaces 110, as described above with reference to optical systems 125 and 126.

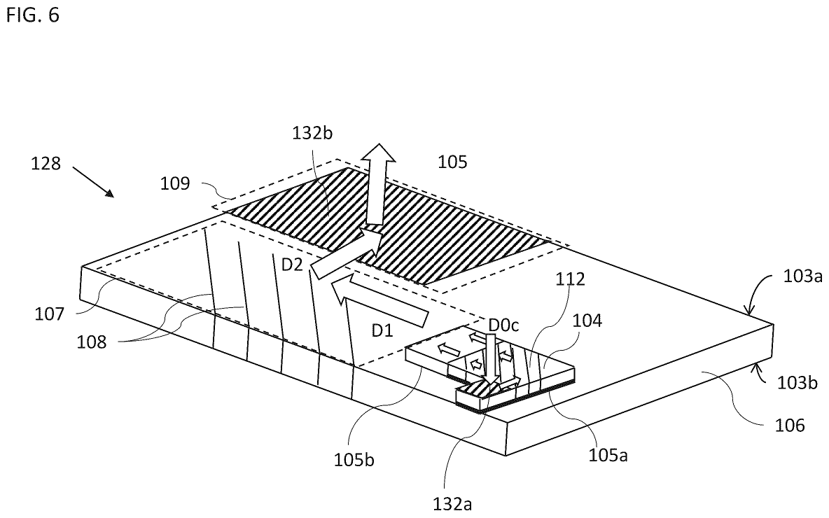

Turning now to FIG. 6, this shows a further optical system, generally designated 128, illustrating an alternative diffractive (or mixed “hybrid”) implementation. In this case, the input coupler is implemented as a first diffractive optical element 132a associated with a surface of CLE 104, and the second redirecting configuration is a second diffractive optical element 132b configured to match the first diffractive optical element so as to cancel out chromatic dispersion generated by the first diffractive optical element. In this case, injection of the image is typically substantially perpendicular to the major surfaces of the CLE and LOE, with the chief ray shown here as D0c.

A further implementation, not shown, may combine the diffractive elements 130a and 130b of FIG. 5A with diffractive elements 132a and 132b of FIG. 6 to implement a fully diffractive implementation with two pairs of diffractive elements which cancel out their respective dispersion effects.

In all of the above cases, LOE 106 has been illustrated schematically as a rectangular element. In typical practical embodiments, the LOE is shaped to fit into a suitable support structure, such as a glasses frame, that supports the LOE correctly aligned in facing relation to an eye of the user. A display device may typically include two such optical devices, each fed with a collimated image by a miniature image projector, and also includes onboard components such as processing components, a power supply and various communications subsystems, all as required for each application, and as generally known in the art. These additional components are not per se part of the invention, and are therefore not described here in detail.

It will be appreciated that the above descriptions are intended only to serve as examples, and that many other embodiments are possible within the scope of the present invention as defined in the appended claims.

What is claimed is:

1. An optical system comprising:
(a) an aperture-expanding lightguide optical element (LOE) having a pair of mutually parallel major surfaces, separated by a first thickness, said LOE supporting propagation of light by internal reflection at said major surfaces, said LOE having:
(i) a first redirecting configuration deployed in a first region of said LOE for progressively redirecting light propagating in a first in-plane direction to propagate in a second in-plane direction towards a second region of the LOE, and
(ii) a second redirecting configuration deployed in the second region of said LOE for progressively redirecting light propagating in the second in-plane direction out of the LOE for viewing by a viewer; and
(b) a coupling-in arrangement comprising:
(i) a coupling lightguide element (CLE) having a pair of mutually parallel surfaces separated by a second thickness that is no more than half of said first thickness, said parallel surfaces of said CLE having an area that is no more than 10 percent of an area of said major surfaces of said LOE, one of said surfaces of said CLE being bonded to one of said major surfaces of said LOE at an interface, at least part of said interface provided with a beam splitter coating having a reflectivity of at least 50%, and
(ii) an input coupler deployed to couple light corresponding to a collimated image into said CLE.

2. The optical system of claim 1, wherein said input coupler is a coupling prism presenting an input surface that is substantially perpendicular to a chief ray of the collimated image coupled in to said CLE.

3. The optical system of claim 1, wherein said first redirecting configuration comprises a first set of mutually parallel internal partially reflecting surfaces non-parallel to said major surfaces, and wherein said second redirecting configuration comprises a second set of mutually parallel internal partially reflecting surfaces obliquely angled to said major surfaces.

4. The optical system of claim 1, wherein said CLE further comprises a preliminary aperture expansion arrangement.

5. The optical system of claim 4, wherein said preliminary aperture expansion arrangement comprises a set of mutually parallel internal partially reflecting surfaces within said CLE for progressively redirecting the light coupled in by said input coupler.

6. The optical system of claim 5, wherein said input coupler is deployed so that a chief ray of the collimated image coupled in to said CLE propagates in said first in-plane direction after a single reflection from one of said internal partially reflecting surfaces of said CLE.

7. The optical system of claim 5, wherein said input coupler is deployed so that a chief ray of the collimated image coupled in to said CLE propagates in said first in-plane direction after being twice reflected from said internal partially reflecting surfaces of said CLE.

8. The optical system of claim 4, wherein said preliminary aperture expansion arrangement comprises a diffractive optical element associated with said CLE.

9. The optical system of claim 8, wherein said input coupler is deployed so that a chief ray of the collimated image coupled in to said CLE propagates in said first in-plane direction after being redirected twice by diffraction at said diffractive optical element so as to cancel out chromatic dispersion generated by a first diffraction at said diffractive optical element.

10. The optical system of claim 8, wherein said first redirecting configuration of said LOE is a diffractive optical element configured to match said diffractive optical element of said CLE so as to cancel out chromatic dispersion generated by said diffractive optical element of said CLE.

11. The optical system of claim 4, wherein a part of said interface between said CLE and said LOE that underlies said preliminary aperture expansion arrangement is provided with a highly reflective coating.

12. The optical system of claim 1, wherein said input coupler is a first diffractive optical element associated with a surface of said CLE, and wherein said second redirecting configuration is a second diffractive optical element configured to match said first diffractive optical element so as to cancel out chromatic dispersion generated by said first diffractive optical element.

13. The optical system of claim 1, wherein said beam splitter coating has a reflectivity of between 55% and 95%.

14. The optical system of claim 1, wherein said beam splitter coating has a reflectivity of between 65% and 90%.

15. The optical system of claim 1, wherein said beam splitter coating has a reflectivity which progressively decreases along the first in-plane direction.

16. The optical system of claim 1, wherein said second thickness is between 20% and 40% of said first thickness.
